(19) United States
(12) Patent Application Publication
(10) Pub. No.: US 2021/0192935 A1
(43) Pub. Date: Jun. 24, 2021

(54) INFRARED CONTROL DEVICE

(71) Applicant: Askey Computer Corp., NEW TAIPEI CITY (TW)

(72) Inventors: Yu-Ting Hsiao, NEW TAIPEI CITY (TW); Che-Wei Hsu, NEW TAIPEI CITY (TW); Yu-Cheng Chou, NEW TAIPEI CITY (TW); Xiao-Juan Lin, NEW TAIPEI CITY (TW); Ming-Yi Wang, NEW TAIPEI CITY (TW)

(21) Appl. No.: 17/120,501

(22) Filed: Dec. 14, 2020

(30) Foreign Application Priority Data
Dec. 24, 2019 (CN) 201911349133.9

(51) Int. Cl. G08C 23/04; G08C 17/02

(52) U.S. Cl. CPC G08C 23/04; G08C 17/02

(57) ABSTRACT

An infrared control device is configured for use in a mesh network environment to control a controlled device by transmitting an infrared signal. The controlled device includes an identification tag. The identification tag includes a first control instruction. The control device includes a tag identification module and a database. The tag identification module scans the identification tag to identify the first control instruction. The database is electrically connected to the tag identification module to store the first control instruction.

### CROSS-REFERENCE TO RELATED APPLICATION

This non-provisional application claims priority under 35 U.S.C. § 119(a) to Patent Application No. 201911349133.9 filed in China, P.R.C. on Dec. 24, 2019, the entire contents of which are hereby incorporated by reference.

### BACKGROUND

### Technical Field

The instant disclosure relates to an infrared control device, and in particular, to an infrared control device configured for use in a mesh network environment to control a controlled device.

### Related Art

With the advancement in science and technology, the use of a control device to control a controlled device via a network has come into being in the prior art. However, a setup of such a control mode requires the control device to download a control instruction for the controlled device from a cloud database via the network, which requires the control device to be connected to an external network. If the control device fails to be connected to the cloud database, the downloading cannot be performed, which is troublesome for users. Therefore, there is a need for improvements in the prior art.

### SUMMARY

A primary objective of the instant disclosure is to provide an infrared control device configured for use in a mesh network environment to control a controlled device.

To achieve the objective, in an embodiment, the infrared control device of the instant disclosure is configured for use in a mesh network environment to control a controlled device by transmitting an infrared signal. The controlled device includes an identification tag. The identification tag includes a first control instruction. The control device includes a tag identification module and a database. The tag identification module scans the identification tag to identify the first control instruction. The database is electrically connected to the tag identification module to store the first control instruction.

To achieve the objective, in another embodiment, the infrared control device of the instant disclosure is configured for use in a mesh network environment to control a controlled device by transmitting an infrared signal. The infrared control device is connected to an electronic device by means of a signal. The electronic device includes a tag identification module. The controlled device includes an identification tag. The identification tag includes a first control instruction. The tag identification module scans the identification tag to identify the first control instruction. The control device includes a tag identification module and a database. The tag identification module scans the identification tag to identify the first control instruction. The database is electrically connected to the tag identification module to store the first control instruction.

The infrared control devices of the instant disclosure record the control instructions for the controlled device (e.g., a home appliance) in the identification tag, so that the infrared control devices can create the database of the control instructions for the controlled device (e.g., a home appliance), without downloading the control instructions from a cloud database, thus eliminating the need in the prior art for a connection to the cloud database to download the control instructions for the controlled device (e.g., a home appliance).

### BRIEF DESCRIPTION OF THE DRAWINGS

FIG. 1 is a schematic diagram of a first embodiment of an infrared control device according to the instant disclosure.

FIG. 2 is a schematic diagram of a second embodiment of an infrared control device according to the instant disclosure.

### DETAILED DESCRIPTION

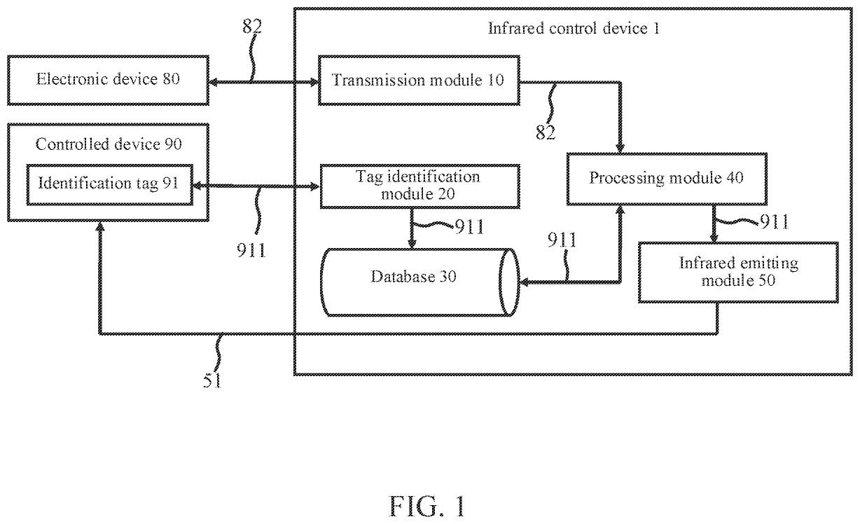

In order to provide a clear description of the technical contents, objectives, and advantages of the instant disclosure, embodiments of the instant disclosure are further described in detail with reference to the accompanying drawings. Referring now to FIG. 1, FIG. 1 is a schematic diagram of a first embodiment of an infrared control device according to the instant disclosure.

According to the first embodiment of the instant disclosure, as shown in FIG. 1, the infrared control device 1 of the instant disclosure is configured for use in a mesh network environment to control a controlled device 90, where the infrared control device 1 is connected to an electronic device 80 by means of a signal, the controlled device 90 includes an identification tag 91, and the identification tag 91 includes a first control instruction 911. In this embodiment, the controlled device 90 is a general home appliance or any device that is capable of receiving an infrared signal. The identification tag 91 is an RFID tag or a QR code tag. The first control instruction 911 includes a serial number of an appliance, a region, a type of a home appliance, a label, a code name, a function, a control instruction for the controlled device 90, etc. The electronic device 80 may be a portable mobile device.

As shown in FIG. 1, in the first embodiment, the infrared control device 1 of the instant disclosure includes a transmission module 10, a tag identification module 20, a database 30, a processing module 40, and an infrared emitting module 50. The tag identification module 20 scans the identification tag 91 to identify the first control instruction 911. In this embodiment, the tag identification module 20 is an optical identification device or a short-range wireless communication device. The optical identification device is a camera or a barcode scanner, and the short-range wireless communication device is a near-field communication reading device or a radio frequency identification reading device. The database 30 is electrically connected to the tag identification module 20 to store the first control instruction 911. Therefore, the infrared control device 1 can load the first control instruction 911 for the controlled device 90 into the database 30 of the infrared control device 1 without being connected to a cloud database via a network.

As shown in FIG. 1, the transmission module 10 is electrically connected to the processing module 40. The transmission module 10 is capable of wireless transmission to receive a second control instruction 82 transmitted from the electronic device 80. In this embodiment, the electronic device 80 transmits the second control instruction 82 to the transmission module 10 through a wireless communication protocol such as a WiFi communication protocol or a Bluetooth communication protocol. The infrared emitting module 50 is electrically connected to the processing module 40. The processing module 40 searches the database 30 according to the second control instruction 82 to convert the second control instruction 82 to the first control instruction 911. The first control instruction 911 is transmitted by the infrared emitting module 50 as an infrared signal 51 to control the controlled device 90.

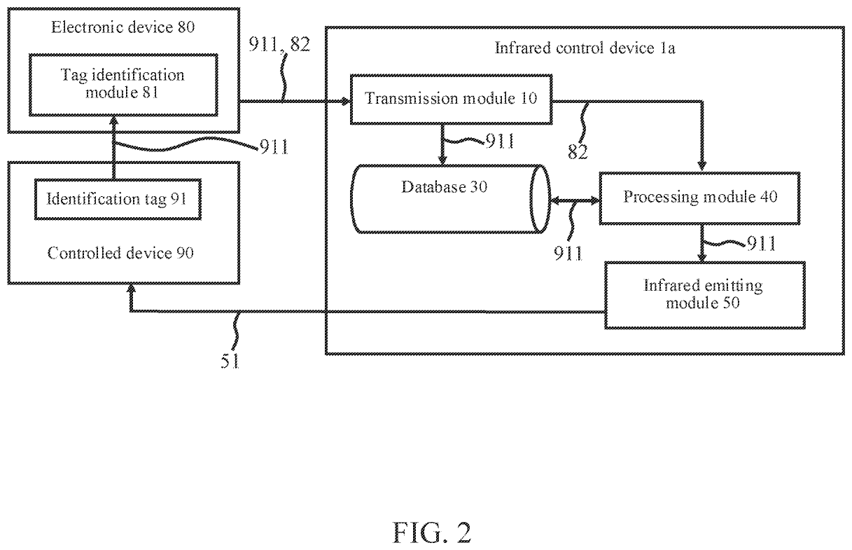

Referring now to FIG. 2, FIG. 2 is a schematic diagram of a second embodiment of an infrared control device according to the instant disclosure is shown.

As shown in FIG. 2, in the second embodiment, an infrared control device 1a is configured for use in a mesh network environment to control a controlled device 90. The infrared control device 1a is connected to an electronic device 80 by means of a signal. The electronic device 80 includes a tag identification module 81. The controlled device 90 includes an identification tag 91. The identification tag 91 includes a first control instruction 911. The tag identification module 81 scans the identification tag 91 to identify the first control instruction 911. In this embodiment, the tag identification module 81 is an optical identification device or a short-range wireless communication device. The optical identification device is a camera or a barcode scanner, and the short-range wireless communication device is a near-field communication reading device or a radio frequency identification reading device.

The infrared control device 1a of the instant disclosure includes a transmission module 10, a database 30, a processing module 40, and an infrared emitting module 50. The transmission module 10 receives the first control instruction 911 transmitted from the electronic device 80. The database 30 is electrically connected to the transmission module 10 to store the first control instruction 911. The infrared emitting module 50 is electrically connected to the processing module 40. The processing module 40 searches the database 30 according to a second control instruction 82 transmitted from the electronic device 80 to convert the second control instruction 82 to the first control instruction 911. The first control instruction 911 is transmitted by the infrared emitting module 50 as an infrared signal to control the controlled device 90. In this embodiment, the electronic device 80 transmits the first control instruction 911 and the second control instruction 82 to the transmission module 10 through a wireless communication protocol such as a WiFi communication protocol or a Bluetooth communication protocol.

The infrared control devices 1 and 1a of the instant disclosure record the control instructions 911 for the controlled device 90 (e.g., a home appliance) in the identification tag 91, so that the infrared control devices 1 and 1a can create the database of the control instructions for the controlled device 90 (e.g., a home appliance), without downloading the control instructions from a cloud database, thus eliminating the need in the prior art for a connection to the cloud database to download the control instructions for the controlled device 90 (e.g., a home appliance).

Although the instant disclosure has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An infrared control device configured for use in a mesh network environment to control a controlled device by transmitting an infrared signal, wherein the controlled device comprises an identification tag, the identification tag comprises a first control instruction, and the infrared control device comprises:
a tag identification module configured to scan the identification tag to identify the first control instruction; and
a database electrically connected to the tag identification module to store the first control instruction.

2. An infrared control device configured for use in a mesh network environment to control a controlled device by transmitting an infrared signal, wherein the infrared control device is connected to an electronic device by means of a signal, the electronic device comprises a tag identification module, the controlled device comprises an identification tag, the identification tag comprises a first control instruction, the tag identification module scans the identification tag to identify the first control instruction, and the infrared control device comprises:
a transmission module configured to receive the first control instruction transmitted from the electronic device; and
a database electrically connected to the transmission module to store the first control instruction.

3. The infrared control device according to claim 2, wherein the electronic device transmits the first control instruction to the transmission module through a wireless communication protocol.

4. The infrared control device according to claim 3, wherein the wireless communication protocol is a WiFi communication protocol or a Bluetooth communication protocol.

5. The infrared control device according to claim 1, wherein the identification tag is an RFID tag or a QR code tag.

6. The infrared control device according to claim 2, wherein the identification tag is an RFID tag or a QR code tag.

7. The infrared control device according to claim 5, wherein the tag identification module is a camera or a barcode scanner.

8. The infrared control device according to claim 6, wherein the tag identification module is a camera or a barcode scanner.

9. The infrared control device according to claim 7, wherein an optical identification device is a camera or a barcode scanner.

10. The infrared control device according to claim 8, wherein an optical identification device is a camera or a barcode scanner.

11. The infrared control device according to claim 7, wherein a short-range wireless communication device is a near-field communication reading device or a radio frequency identification reading device.

12. The infrared control device according to claim 8, wherein a short-range wireless communication device is a near-field communication reading device or a radio frequency identification reading device.

13. The infrared control device according to claim 1, further comprising a processing module, a transmission module, and an infrared emitting module, wherein the processing module is electrically connected to the infrared emitting module and the transmission module, the transmission module receives a second control instruction transmitted from an electronic device, and the processing module searches the database according to the second control instruction to convert the second control instruction to the first control instruction, and the first control instruction is transmitted by the infrared emitting module as the infrared signal to control the controlled device.

14. The infrared control device according to claim 2, further comprising a processing module and an infrared emitting module, wherein the infrared emitting module is electrically connected to the processing module, the processing module searches the database according to a second control instruction transmitted from the electronic device to convert the second control instruction to the first control instruction, and the first control instruction is transmitted by the infrared emitting module as the infrared signal to control the controlled device.
